(19) United States
(12) Patent Application Publication
(10) Pub. No.: US 2010/0307793 A1
(43) Pub. Date: Dec. 9, 2010

(54) INSULATOR ARRANGEMENT

(75) Inventor: Bernd Kruska, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Muenchen (DE)

(21) Appl. No.: 12/744,768

(22) PCT Filed: Oct. 28, 2008
(86) PCT No.: PCT/EP08/64562

§ 371 Date: May 26, 2010

(30) Foreign Application Priority Data
Nov. 26, 2007 (DE) 10 2007 057 265.6

(51) Int. Cl. H01B 17/56

(52) U.S. Cl. 174/139; 174/212

(57) ABSTRACT

An insulator configuration has a first stop point and a second stop point. A shank which has a non-circular enveloping contour is formed between the stop points. The shank is enclosed by at least one shield. The shield has an enveloping contour of the same type as the shank.

The invention relates to an insulator arrangement with a first stop point and a second stop point, between which a shank with a non-circular enveloping contour extends, which shank is surrounded by at least one shield.

Such an insulator arrangement is known, for example, from the product specification Bowthorpe MV Surge Arresters OCP, Open Cage Polymeric series. Said product specification describes an insulator arrangement which has been provided with stop points at one end, the stop points delimiting a shank. The shank has a substantially parallelepipedal structure and is surrounded by a plurality of shields.

Such insulator arrangements are intended for outdoor use, for example, and therefore need to maintain corresponding leakage parts at their outer surface in order to ensure sufficient potential isolation even in adverse external conditions. For this purpose, the shank and the shields need to be dimensioned correspondingly.

In order to provide resistive structures, it is advantageous to equip the insulator arrangement with a low mass and a low volume in order to be insensitive to loads due to wind pressure, for example.

The object of the invention is therefore to develop an insulator arrangement of the type mentioned at the outset in such a way that said insulator arrangement has a low mass and a low volume alongside good electrical properties.

The object is achieved according to the invention with an insulator arrangement of the type mentioned at the outset by virtue of the fact that the shield has an identical enveloping contour to the shank.

The known insulator arrangement has a shank with a substantially rectangular enveloping contour. This non-circular enveloping contour of the shank is surrounded by shields. In this case, the shields have circular enveloping contours. In order to provide a sufficient leakage path length on the surface over all critical extents of the shank between the stop points, the shields need to be dimensioned with respect to protruding corners of the shank. Correspondingly, this results in overdimensioned regions, as a result of the circular configuration of the shields, for those sections of the shank which are positioned between the corners.

By virtue of a non-circular enveloping contour, it is possible to form compact, torsion-resistant shanks which can withstand even elevated bending stress when used outdoors. Matching the enveloping contour of the shields to the enveloping contour of the shank ensures that leakage paths which are clamped between the stop points in a manner distributed over the circumference of the shank each have a sufficient length over shank and shield. Overdimensioning of the shields and therefore an unnecessary increase in mass is thus prevented. By virtue of a reduction in the mass of the shields it is possible to overall reduce the susceptibility of the insulator arrangement to loads due to wind pressure. As an alternative, provision can also be made for the material saved to be used to configure the shields themselves to be mechanically more stable.

In this case, provision can be made for the shank to have a non-circular enveloping contour, i.e. the shank can have, for example, an ellipsoidal enveloping contour and a shield surrounding the shank can likewise have an identical ellipsoidal enveloping contour. In this case, the depth of the shield based on corresponding surface normals of the shank which are perpendicular to the outer surface is always the same. This ensures that the enveloping contour of the shank and the enveloping contour of the shield are identical and said enveloping contours differ only in terms of the dimension of the extended length of the circumference of the enveloping contours.

In this case, provision can also be made for the shank to have regions of different cross sections along its profile. The shield which extends in the respective region of the shank is in each case matched to the enveloping contour of the region of the shank which the shield surrounds. In this case, it is thus also ensured that, given different configurations of different regions of the shank in terms of its enveloping contours, the shields provided in each case there bring about an identical leakage path extension over the entire circumference of the respective region of the shank. It is thus possible, for example, to equip insulating arrangements with shanks which have different regions with different enveloping contours. Shields positioned in the respective regions assume the respective enveloping contour. Thus, different regions of the shank can be configured with different shields, wherein potential leakage parts which run between the stop points in a manner distributed over the circumference of the shank are always approximately of equal length.

One advantageous configuration can further provide for the enveloping contour of the shank and the enveloping contour of the shield to each extend in planes which are aligned substantially parallel to one another.

In a projection of the insulator arrangement, preferably in the direction of a longitudinal axis of the insulator arrangement, wherein the longitudinal axis connects the two stop points of the insulator arrangement to one another, the enveloping contours are visible. In this case, the enveloping contours each have identical shapes, wherein these shapes are preferably aligned symmetrically with respect to the longitudinal axis. The enveloping contours thus in each case extend in planes which are aligned parallel to the projected area. As a result, each of the enveloping contours is in planes which are arranged approximately parallel to one another.

An advantageous configuration can provide, for example, for the enveloping contour to be a substantially polygonal enveloping contour.

A polygonal enveloping contour makes it possible to form an insulator arrangement which can be integrated easily into mounting systems. In a simplified case, for example, the mounting of the insulator arrangements can be performed in a space-saving manner whilst avoiding interspaces and cavities. Suitable polygonal enveloping contours are, for example, polygonal chains with three, four, five, six, seven etc. corners. Advantageously, the shank has the structure of a prism. The prism should preferably run in a straight line, with the stop points being arranged in the region of the end-side bases of the prism.

In this case, provision can advantageously be made for corners of the polygonal enveloping contour to be broken.

By breaking the corners, for example by rounding off the corners, sharp-edged projections on the insulator arrangement are avoided. As a result, insulator arrangements according to the invention can also be used, for example, in the high-voltage range and in the ultra-high-voltage range, i.e. at voltage levels of above 1000 V, several 10 000 and 100 000 V.

However, breaking of the corners can also be performed, for example, by said corners being truncated once, twice, three times or more times.

In this case, provision can advantageously be made for positions of corners of the substantially polygonal enveloping contour to be fixed by connecting elements extending between the stop points.

The stop points can serve the purpose of delimiting the insulator arrangement at the ends. In order to impart mechanical stability to the insulator arrangement, the stop points can be connected to one another by means of connecting elements. Rods, hoops, lugs, elastomeric elements etc. can be used, for example, as connecting elements, with the result that a sufficiently rigid structure can be formed between the stop points. The position of the connecting elements can in this case be provided to be shifted radially outwards, based on the longitudinal axis which extends between the stop points, and radially with respect thereto, with the result that, depending on the number of connecting elements selected, the corners of a polygonal enveloping contour are predetermined in a projection in the direction of the longitudinal axis. A polygonal enveloping contour of a low-mass shank is predetermined by the corners. In the case of the polygonal enveloping contour, corresponding linear sections extend between the corners and, when using a shank with a continuously identical enveloping contour, form outer surface areas on the shank which represent planar sections of the outer surface. A plurality of outer surface areas are then positioned with respect to one another in such a way that the connecting elements are positioned in the touching regions (corners) of the sections within the shank. In order to configure dielectrically favorable shapes and mechanically favorable shapes, the shank can be broken at the corners in the same way as the shields.

At least one connecting element can be positioned in the region of a corner. The corner is preferably part of a body edge of a prismatic shank, which runs in the direction of the connecting element.

In order to provide an embodiment of shank and shield which is suitable for outdoors, an insulating sheath can be provided between the stop points of the insulator arrangement. This insulating sheath can be shaped, for example, from an organic or inorganic material, for example from ceramics, polymers or the like. The insulating material can in this case also protect the connecting elements which may be provided from external effects and provides the shank with its outer configuration. The shields can be integrally formed on the insulating sheath.

A further advantageous configuration can provide for at least one varistor element to be arranged integrated in the shank between the stop points.

Varistor elements are electrical components which have a variable impedance. In this case, the impedance varies depending on a voltage applied via the varistor element. Below a limit voltage, a varistor element should have an impedance which ideally tends toward infinity. As a limit voltage is reached or exceeded, a varistor element should ideally have an impedance which tends toward zero. Such voltage-dependent varistor elements can be used, for example, for forming overvoltage protection devices in electrical systems. Such overvoltage protection devices are also referred to as surge arrestors if they are used in electrical energy transmission systems. In this case, the varistor elements are used to suppress overvoltages which occur, for example, during switching operations or lightning strikes etc., by the temporary formation of a ground-fault current path and thus to avoid irreparable damage to insulating materials within the electrical energy transmission system as a result of overvoltages. When integrating the varistor element in the shank, provision can be made, for example, for the varistor element to comprise a plurality of varistor blocks, with the connecting elements being arranged distributed over the circumference, and the connecting elements connecting the stop points to one another, and the individual varistor blocks being held in a force-fitting or form-fitting manner in the interior of a cage formed from the connecting elements and the stop points. In this case, the stop points can be provided for making electrical contact between the varistor element and firstly an electrical conductor provided for voltage conduction and secondly a ground potential. As such, the insulator arrangement can then serve the purpose, for example, of holding a conductor track and can provide a protective function via the varistor element integrated in the interior.

It can furthermore advantageously be provided for the enveloping contour of the shank to be different than the enveloping contour of the varistor element.

The provision of different enveloping contours for the shank and the varistor element makes it possible to form interstices in which the connecting elements can positioned. It is thus possible to provide the shank with a non-circular cross section, for example a polygonal cross section, and to transfer this cross section to the circumferential contour of the shield. As a result, the dielectric strength of the insulating arrangement is still provided even when a varistor element is integrated. Outer sections of the surface of the insulating arrangement have one and the same length of potential leakage paths between the stop points. As a result, overdimensioning of the shield or weak points in the shield are prevented. Thus, a homogeneous voltage distribution over the insulator arrangement can be brought about.

A further advantageous configuration can provide for an axis which is surrounded by the enveloping contours to run between the first stop point and the second stop point.

An axis which runs between the stop points can be, for example, the longitudinal axis of an insulator arrangement. In this case, assemblies can be arranged symmetrically with respect to the longitudinal axis, with the result that the enveloping contours surround the axis and an elongate body is produced. The insulator arrangement can thus reach a considerable height in the direction of the longitudinal axis given a small base area, with the result that long distances can be covered by means of the insulator arrangement. It is thus possible to isolate potential differences of several 10 or 100 000 volts, for example, using a single insulator arrangement.

One advantageous configuration can provide for the enveloping contour of the shield to have a substantially rectangular structure.

A substantially rectangular enveloping contour makes it possible to reduce volume and thus to configure insulator arrangements with a reduced mass which have sufficient mechanical strength and dielectric strength. In this case, it is in particular, but not exclusively, the shank which is responsible for providing the mechanical strength of the insulator arrangement. It is in particular, but also not exclusively, the shield which is used for providing the sufficient electrically insulating properties of the insulator arrangement. The abutment edges formed at the corners need to be homogenized in a simple manner by being rounded off at the rectangular cross section. Furthermore, in the case of a rectangular enveloping contour, connecting elements which pass longitudinally through the shank at four corner points are used in a simple manner. When arranging a plurality of shields at a distance from one another, said shields form, with their body edges, a right-parallelepipedal structure, which surrounds the corresponding right-parallelepipedal structure of the shank, wherein the shank passes through the right-parallelepipedal structure of the shields at one end.

Provision can advantageously be made for at least one of the stop points to have a rotationally symmetrical, electrically conductive contact-making section, whose outer surface area is embedded in an insulating material.

By using rotationally symmetrical, electrically conductive contact-making sections at at least one stop point, it is possible, for example, to make contact with a varistor element integrated in the shank through the insulating material. The insulating material can be, for example, a silicone-like mass, which is used for forming the shield and for terminating the shank. In order to prevent the ingress of foreign matter such as dust or liquids, corresponding embedding of an outer surface area of a contact-making section in the insulating material can be provided. This results in an annularly circumferential terminating seam between the electrically conductive contact-making section and the insulating material. This prevents projections and edges which would represent discontinuities in the bond between the insulating material and the electrically conductive contact-making section and could act as imperfections within the insulating arrangement.

An exemplary embodiment of the invention will be shown schematically using a drawing and described in more detail below.

In the drawing:

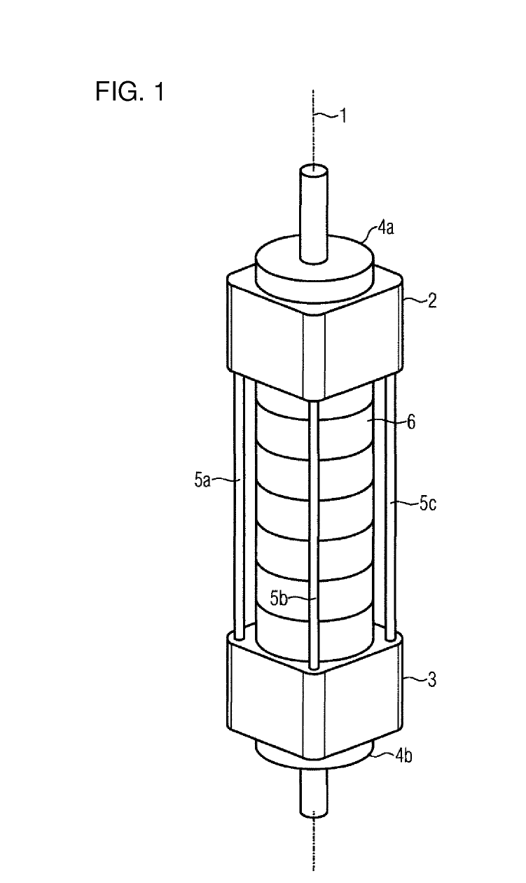

FIG. 1 shows an inner structure of an insulator arrangement,

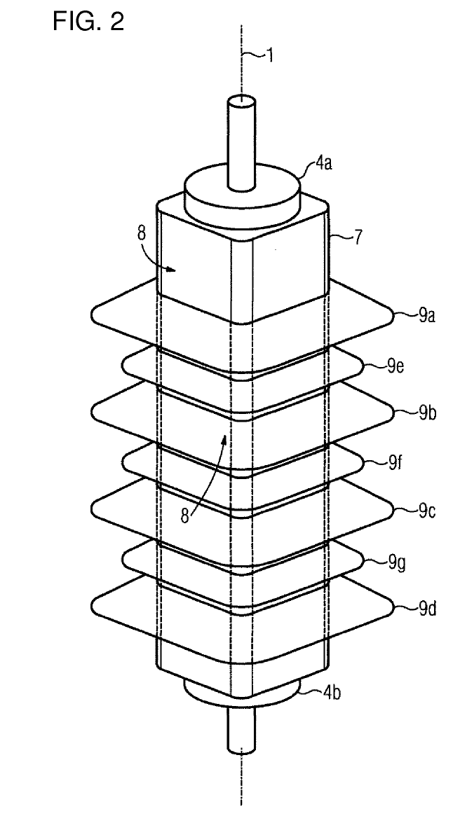

FIG. 2 shows an external view of the insulator arrangement,

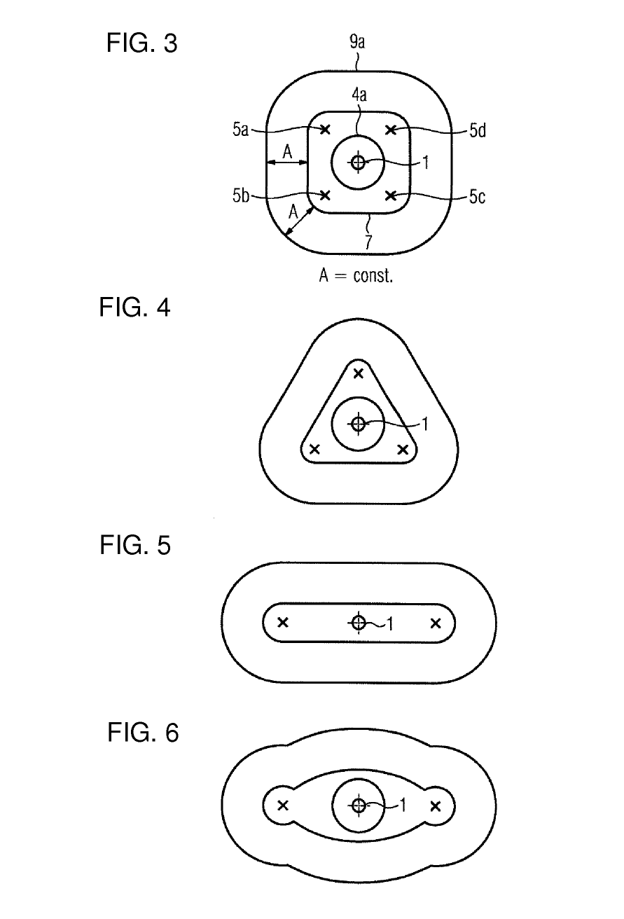

FIG. 3 shows a projection of the insulator arrangement shown in FIG. 2,

FIGS. 3, 4, 5 and 6 show projections of further possible configurations of insulator arrangements.

FIG. 1 shows a perspective view of an insulator arrangement which has been cut away. Said figure shows a first stop point 2 and a second stop point 3, in each case arranged at one end, based on a longitudinal axis 1. In the present exemplary embodiment, the two stop points 2, 3 are designed to be identical and are aligned in opposition to one another. In this case, the stop points 2, 3 are in the form of cast armature bodies, for example, which have a polygonal cross section, in this case a rectangular cross section. In each case electrically conductive contact-making sections 4a, 4b are arranged on the mutually remote sides of the stop points 2, 3. The contact-making sections 4a, 4b are each designed to be rotationally symmetrical and arranged coaxially with respect to the longitudinal axis 1. The electrically conductive contact-making sections 4a, 4b can be an integral part of the stop points 2, 3. However, provision can also be made for said contact-making sections to be arranged replaceably, for example by means of screw-type connections or the like, on the stop points 2, 3. The electrically conductive contact-making sections 4a, 4b are designed to be rotationally symmetrical. In this case, a section with a relatively large diameter and a section with a relatively small diameter are provided. The section with the relatively small diameter serves the purpose of connecting electrical contact-making pieces such as cable lugs or the like. That section of the electrically conductive contact-making sections which has a relatively large diameter provides a cylindrically peripheral outer surface area in order to allow an insulating material which surrounds the inner structure of the insulator arrangement to adjoin.

In order to space the two stop points 2, 3 apart from one another at a rigid angle, the stop points 2, 3 are connected to one another via a plurality of connecting elements 5a, 5b, 5c. The connecting elements 5a, 5b, 5c are in the present case in the form of rods, with four electrically insulating rods being provided which are each arranged in corner regions of the rectangular stop points 2, 3 and are connected thereto. Adhesive joints, plug-type connections, compression joints, screw-type connections etc. can be used for the connection. The connecting elements 5a, 5b, 5c form a cage between the stop points 2, 3, with a varistor element 6 being arranged in the interior of said cage. In the present case, the varistor element 6 is formed from a plurality of varistor blocks arranged one above the other, with the varistor blocks each having a cylindrical structure. The varistor element 6 is connected electrically conductively to the stop points 2, 3 and thereafter to the electrically conducive contact-making sections 4a, 4b. The varistor element 6 with its varistor blocks is aligned coaxially with respect to the longitudinal axis 1. By virtue of corresponding bracing of the stop points 2, 3 by means of the connecting elements 5a, 5b, 5c, the varistor blocks are braced at the ends with respect to one another and a mechanically stable structure is provided for forming an insulator arrangement. In order to protect the insulator arrangement from external influences, provision is made for the insulator arrangement to be sheathed with an insulating material.

FIG. 2 depicts an external view of the insulator arrangement, which has been provided with an insulating sheath 7. A suitable insulating material is silicone, for example. The insulating sheath 7 surrounds the longitudinal axis 1 and conforms to outer surface areas of the electrically conductive contact-making sections 4a, 4b. The stop points 2, 3, the connecting elements 5a, 5b, 5c and the varistor element 6 are protected from direct external influences by the insulating sheath 7. Organic polymers which can be applied, for example by an injection-molding process, a shrinkfit process, an extrusion process or a casting process etc., are in particular suitable as insulating sheath. By way of accommodating the enveloping contour of the stop points 2, 3 and maintaining said enveloping contour, a shank 8 is formed along the longitudinal axis 1, said shank 8 having a non-circular enveloping contour. In the present case, the enveloping contour is substantially rectangular. In this case, the corners of the rectangular enveloping contour are broken by rounded portions.

Corresponding to the structure of the shank 8, shields 9a, 9b, 9c, 9d are arranged on the shank 8, the shields 9a, 9b, 9c, 9d surrounding the shank 8. The shields 9a, 9b, 9c, 9d in this case have an identical enveloping contour to the shank 8. The shields 9a, 9b, 9c, 9d have linear delimitation of the enveloping contour at sections which are opposite the planar outer surface areas of the shank 8. The structure of the enveloping contour of the shank is also taken at the corners of the shank, which are broken in rounded form in the present case, with the result that the shields 9a, 9b, 9c, 9d are also equipped with correspondingly rounded-off corners. In order to ensure that, based on directions of normal vectors of the outer surface of the shank 8, there is always the same leakage-path extending effect of the shields 9a, 9b, 9c, 9d, corresponding matching of the radii is provided at the rounded corners. In the present case, based on the longitudinal axis 1, the rounded corners are aligned coaxially with respect to the same axis (longitudinal axis 1), with the result that the individual rounded sections are parts of circles which are positioned coaxially with respect to one another.

In order to ensure effective leakage-path extension of the shielding, shields with enveloping contours 9e, 9f, 9g which are reduced in size in comparison with the shields 9a, 9b, 9c, 9d are arranged between two mutually spaced-apart shields 9a, 9b, 9c, 9d. The shields with a reduced enveloping contour 9e, 9f, 9g in turn have the same structure as the enveloping contours of the shank 8 and the shields 9a, 9b, 9c, 9d.

FIG. 3 shows a projection of the insulator arrangement shown in FIG. 2 in the direction of the longitudinal axis 1. A longitudinal axis 1 protrudes perpendicularly out of the plane of the drawing, in the same way as in FIGS. 4, 5 and 6. The positions of connecting elements are indicated by X in FIGS. 3, 4, 5 and 6. It can be seen that, owing to the identical structure of the enveloping contours of the shank 8 and of the shields 9a, path lengths which are distributed radially over the circumference from the shank 8 to the peripheral region of a shield 9a, based on the longitudinal axis 1, always have the same absolute value A. This ensures that distances of equal length between the electrically conductive contact-making sections 4a, 4b or between the stop points 2, 3 prevent the formation of leakage current paths. This ensures that no structural weak points are produced on the insulator arrangement, at which weak points preferably leakage currents could form owing to a shortened path.

In addition to the exemplary embodiment shown in FIGS. 1, 2 and 3, further cross sections or enveloping contours for shanks and shields are possible. By way of example, a few structures are shown in projections in FIGS. 4, 5 and 6. The fact that in each case one longitudinal axis 1 is aligned perpendicular to the plane of the drawing is common to FIGS. 4, 5 and 6. Furthermore, the position of connecting elements located in the interior of the insulator arrangement is in each case illustrated by an X in order to in each case connect the stop points of the insulator arrangement to one another. Furthermore, the fact that the depth of the shields, when viewed in the perpendicular direction to the outer surface area of the respective shank, is identical over the entire circumference owing to the selection of identical enveloping contours for the respective shank and the respectively associated shields, is common to each of FIGS. 4, 5 and 6. As a result, the shielding is sufficiently effective even in the case of any desired polygonal or else non-polygonal enveloping contour of the shank. In this case, there is no overdimensioning of individual sections as is the case when using shields with a circular enveloping contour, with the result that structure-related differences in the resistance with respect to the formation of leakage currents on the surface of an insulator arrangement are prevented.

1-10. (canceled)

11. An insulator configuration, comprising:
a first stop and a second stop;
a shank extending between said first stop and said second stop, said shank having a non-circular enveloping contour;
at least one shield surrounding said shank, said at least one shield having an enveloping contour corresponding to the enveloping contour of said shank.

12. The insulator configuration according to claim 11, wherein the enveloping contour of said shank and the enveloping contour of said shield extend in planes aligned substantially parallel to one another.

13. The insulator configuration according to claim 11, wherein the enveloping contour is a substantially polygonal enveloping contour.

14. The insulator configuration according to claim 13, wherein the polygonal enveloping contour is formed with broken corners.

15. The insulator configuration according to claim 13, which comprises connecting elements extending between said first and seconds stops and fixing corners of the substantially polygonal enveloping contour.

16. The insulator configuration according to claim 11, wherein at least one varistor element is disposed between said first and second stops and integrated in said shank.

17. The insulator configuration according to claim 16, wherein the enveloping contour of said shank is different from an enveloping contour of said varistor element.

18. The insulator configuration according to claim 11, wherein an axis, surrounded by the enveloping contours, is defined between said first stop and said second stop.

19. The insulator configuration according to claim 13, wherein the enveloping contour of said shield has a substantially rectangular structure.

20. The insulator configuration according to claim 11, wherein at least one of said first and second stops includes a rotationally symmetrical, electrically conductive contact-making section formed with an outer surface area embedded in an insulating material.
